(19) United States
(12) Patent Application Publication
(10) Pub. No.: US 2026/0116299 A1
(43) Pub. Date: Apr. 30, 2026

(54) VEHICULAR CAMERA WITH REDUCED PACKAGING DEPTH

(71) Applicant: Magna Electronics Inc., Auburn Hills, MI (US)

(72) Inventors: Xiyuan Liu, Moembris (DE); Alexandru Palii, Iasi (RO)

(21) Appl. No.: 19/363,886

(22) Filed: Oct. 21, 2025

Related U.S. Application Data
(60) Provisional application No. 63/711,832, filed on Oct. 25, 2024.
(60) Provisional application No. 63/711,823, filed on Oct. 25, 2024.

(51) Int. Cl. B60R 1/12; B60R 1/04; G02B 3/00; H04N 7/18; H04N 23/55; H04N 23/57; H04N 23/695

(52) U.S. Cl. CPC B60R 1/12; B60R 1/04; G02B 3/0087; H04N 7/183; H04N 23/55; H04N 23/57; H04N 23/695; B60R 2001/1253

(57) ABSTRACT

A vehicular cabin monitoring system includes a camera disposed at an interior portion of an interior cabin of a vehicle. The camera is accommodated behind an outer panel of a vehicular component and includes an image sensor and a gradient index (GRIN) lens having a uniform thickness in an axial direction and a variable index of refraction in a radial direction. The camera views within the interior cabin through a region of the outer panel. Light incident at the region of the outer panel of the vehicular component passes through the outer panel and passes through the GRIN lens and is imaged at the image sensor. Image data captured by the camera is processed for at least one of an occupant monitoring function and a driver monitoring function.

### CROSS REFERENCE TO RELATED APPLICATIONS

The present application claims the filing benefits of U.S. provisional application Ser. No. 63/711,832, filed Oct. 25, 2024, and U.S. provisional application Ser. No. 63/711,823, filed Oct. 25, 2024, which are hereby incorporated herein by reference in their entireties.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known.

Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular cabin monitoring system includes a camera disposed at an interior portion of an interior cabin of a vehicle and viewing within the interior cabin of the vehicle. The camera is accommodated by a vehicular component within the interior cabin of the vehicle, such as an interior rearview mirror assembly, a display device, a pillar of the vehicle and the like. The camera is accommodated behind an outer panel of the vehicular component, such as a mirror reflective element of the mirror assembly. The camera includes a printed circuit board (PCB), an image sensor and an objective lens. The image sensor includes a CMOS imaging array having at least one million photosensors arranged in rows and columns. An imager plane of the camera is perpendicular to a plane of the outer panel of the vehicular component. A prism is accommodated by the vehicular component behind the outer panel of the vehicular component. Light incident at the outer panel of the vehicular component passes through the outer panel and is incident at the prism. The lens of the camera is disposed between the image sensor and the prism, and light incident at the prism is reflected by the prism to be incident at the objective lens of the camera. The objective lens is disposed at the image sensor so that light incident at the objective lens passes through the objective lens to be incident at the image sensor. The camera is operable to capture image data and the cabin monitoring system includes an electronic control unit (ECU) having electronic circuitry and associated software, including an image processor for processing image data captured by the camera and transferred to the ECU. Image data captured by the camera is processed at the ECU for at least one of an occupant monitoring function and a driver monitoring function.

In some examples, the objective lens is replaced by a gradient index (GRIN) lens. The GRIN lens has a uniform thickness in an axial direction parallel to its longitudinal axis and a variable index of refraction in a radial direction perpendicular to its longitudinal axis. Light passes through the outer panel of the vehicular component to be incident on the GRIN lens, and light incident on the GRIN lens passes through the GRIN lens to be incident on the image sensor of the camera.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of an interior rearview mirror assembly having a cabin monitoring camera and a near infrared light emitter behind a reflective element of the interior rearview mirror assembly;

FIG. 3 is another perspective view of the interior rearview mirror assembly, showing the cabin monitoring camera and light emitters without the reflective element;

FIG. 4 is a schematic diagram of the cabin monitoring camera behind a cover panel at an interior component of the vehicle, with an imager plane of the driver monitoring camera parallel to the cover panel;

FIG. 5 is a schematic diagram of the cabin monitoring camera with the imager plane of the cabin monitoring camera perpendicular to a body panel of the interior component and with a prism directing light passing through the body panel toward a lens and the imager of the cabin monitoring camera;

FIG. 6 is a perspective view of the cabin monitoring camera and prism with the imager plane of the cabin monitoring camera perpendicular to the body panel of the interior component;

FIG. 7 is a schematic diagram of a spherical lens element focusing optical rays passing through the spherical lens element;

FIGS. 8 and 9 are schematic diagrams of a gradient index (GRIN) rod lens element focusing optical rays passing through the GRIN rod lens element;

FIG. 10 is a schematic diagram of an objective lens having a GRIN rod lens element and a plano-convex lens element that cooperate to focus optical rays passing through the objective lens; and

FIG. 11 is a schematic diagram of a prism directing optical rays toward the GRIN lens for focusing of the optical rays.

### DESCRIPTION OF THE PREFERRED EMBODIMENTS

A vehicle vision system and/or driver or driving assist system and/or object detection system and/or alert system and/or driver monitoring system operates to capture images exterior and/or interior of the vehicle and may process the captured image data to monitor occupants of the vehicle and/or display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data.

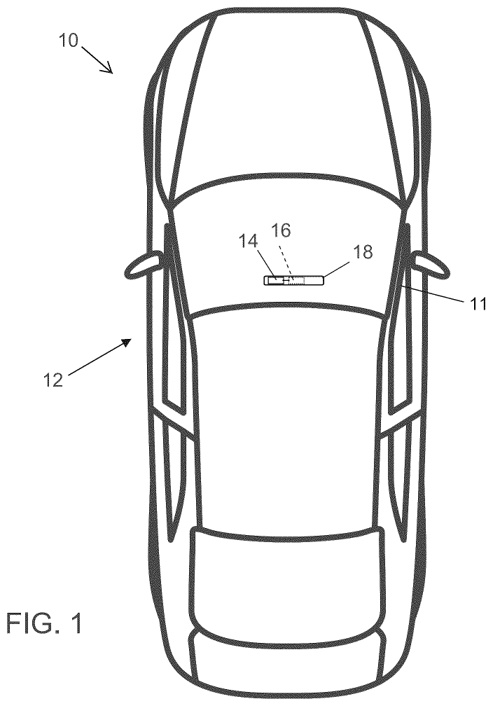

Referring now to the drawings and the illustrative embodiments depicted therein, a vehicle 10 includes a driver monitoring system 12 that includes at least one interior viewing imaging sensor or camera 14 disposed at an interior cabin of the vehicle 10, with the camera having a lens for focusing images at or onto an imaging array or imaging plane or imager of the camera (FIG. 1). The system 12 includes a control or electronic control unit (ECU) 16 that comprises electronic circuitry and associated software, with the electronic circuitry including a data processor or image processor that is operable to process image data captured by the camera or cameras (and may process image data captured by other cameras at the vehicle, such as exterior viewing cameras disposed at locations so as to have respective fields of view exterior of the vehicle) and/or may provide an output to a display device for displaying video images for viewing by the driver of the vehicle. Although shown in the illustrated embodiment as disposed at an interior rearview mirror assembly 18 of the vehicle 10, the driver monitoring camera 14 and ECU 16 may be disposed at any suitable position within the vehicle, such as at a dashboard or gauge cluster or windshield mounted electronics module or the like. The data transfer or signal communication from the camera to the ECU 16 may comprise any suitable data or communication link, such as a vehicle network bus or the like of the equipped vehicle.

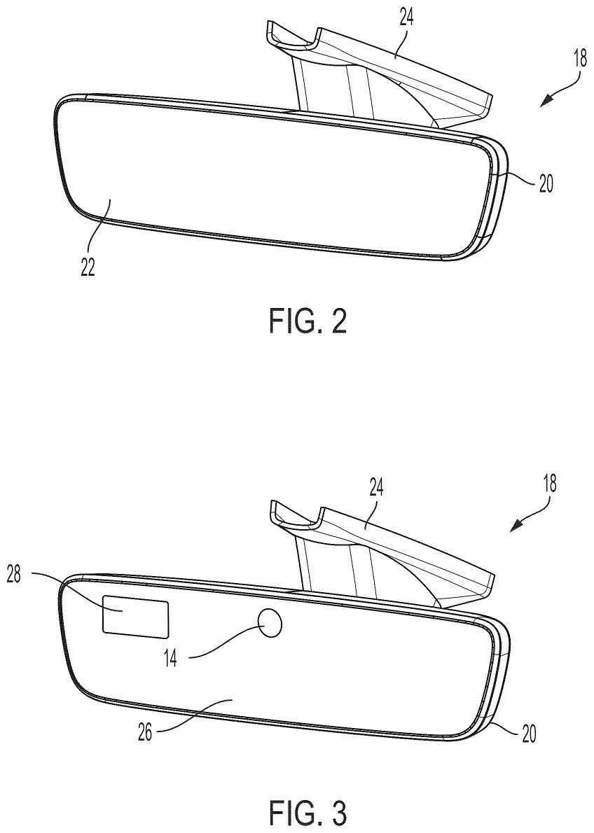

That is, in the illustrated example of FIGS. 2 and 3, the driver monitoring camera 14 is disposed at the interior rearview mirror assembly 18 of the vehicle 10 and the interior rearview mirror assembly 18 includes a casing 20 and a reflective element 22 positioned at a front portion of the casing 20. The mirror assembly 18 is configured to be adjustably mounted to an interior portion of the interior cabin of the vehicle 10 (such as to an interior or in-cabin surface of a vehicle windshield or a headliner of a vehicle or the like) via a mounting structure or mounting configuration or assembly 24. The system includes the camera 14 disposed at and movable with the mirror head. For example, the camera 14 may be accommodated behind the mirror reflective element 22 and view through the mirror reflective element 22 or the camera 14 may be accommodated within a chin region or chin portion of the mirror head 20 that extends along a lower edge region of the mirror reflective element 22. As shown in FIG. 3, the camera 14 is disposed at a back plate 26 (and viewing through an aperture of the back plate) behind the reflective element 22 and viewing through the reflective element toward at least a head region of the driver of the vehicle. The DMS may include one or more infrared (IR) or near infrared (NIR) light emitter(s) 28, which may be disposed at the back plate 26 and may emit light through another aperture of the back plate and through the reflective element 22. The camera 14 captures image data representative of at least a portion of the interior cabin of the vehicle, such as the driver's head region and/or occupant region of the vehicle cabin. The system may utilize aspects of the driver monitoring systems or occupant monitoring systems described in U.S. Pat. Nos. 11,930,264; 11,827,153; 11,780,372 and/or 11,639,134, and/or U.S. Pat. Pub. Nos. US-2025-0074308, and/or International Publication No. WO 2023/220222, and/or U.S. patent application Ser. No. 19/290,465, filed Aug. 5, 2025 (Attorney Docket DON01 P5440), which are all hereby incorporated herein by reference in their entireties.

As discussed further below, the camera 14 captures image data for the driver monitoring system (DMS) 12 and/or an occupant monitoring system (OMS) and the vehicle 10 may optionally include a plurality of cameras that view respective regions of the interior cabin of the vehicle. The interior viewing cameras may be disposed at or behind panels or vehicular components within the interior cabin of the vehicle that have limited packaging space for accommodating the camera. For example, respective cameras may be placed at the interior rearview mirror assembly 18, behind display screens (e.g., an infotainment display screen or a gauge cluster display screen), inside an A-pillar 11 of the vehicle 10 (or optionally a B-pillar, C-pillar and/or D-pillar of the vehicle), inside a steering wheel of the vehicle 10, at a steering column of the vehicle 10 and the like.

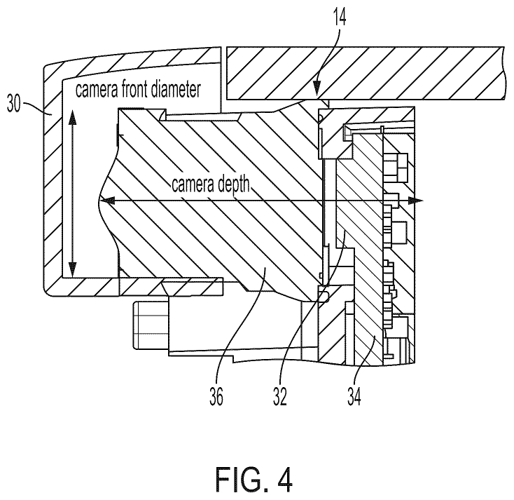

As shown in FIG. 4, the camera 14 may be disposed at or behind a vehicular component and view through a cover element or lens element 30 of the vehicular component. For example, the camera 14 may be disposed at or behind a panel of an interior component of the vehicle, such as a body panel within the interior cabin of the vehicle at an A-pillar of the vehicle, and the cover element 30 is disposed at the body panel. A plane of an outer surface of the cover element 30 may be substantially parallel to a plane of the body panel at the interior component, and the cover element 30 may be coplanar with or slightly recessed from or slightly proud of an outer surface of the body panel. In some examples, the camera 14 is disposed at the back plate 26 of the mirror assembly 18 and the cover element 30 is at a chin region of the mirror assembly at or below a lower edge region of the mirror reflective element 22. When the camera 14 is disposed at the mirror assembly 18, a plane of an outer surface of the cover element 30 may be substantially parallel to a plane of the mirror reflective element 22 or disposed at an oblique angle relative to the plane of the mirror reflective element (such as 5 degrees or less, 10 degrees or less, 15 degrees or less and the like).

An image sensor or imaging plane 32 of the camera 14 may be disposed parallel to the mirror reflective element 22 and/or the cover element 30. Thus, the packaging depth needed to accommodate the camera 14 behind the vehicular component is substantially equal to a depth of the camera assembly 14 when the camera 14 views at an angle that is substantially perpendicular relative to the outer surface of the vehicular component (e.g., the cover element 30 or the mirror reflective element 22). That is, the camera 14 includes the image sensor 32 disposed at a printed circuit board (PCB) 34 and an objective lens or lens barrel 36 having one or more lens elements or optic elements that is disposed in front of the image sensor 32. The image sensor 32 views through the objective lens 36 and the cover element 30 to capture image data representative of regions of the interior cabin of the vehicle 10. A primary viewing axis of the camera 14 (that is parallel to a longitudinal axis of the lens barrel 36) may be substantially perpendicular to the plane of the cover element 30 and/or the plane of the mirror reflective element 22. Thus, when the camera 14 views through the cover element 30 at an angle that is substantially perpendicular to the plane of the cover element 30 and/or mirror reflective element 22, the packaging depth of the camera 14 may include the length or depth of the lens 36 of the camera 14, a thickness of the PCB 34 and the image sensor 32, and optionally a space or gap between the image sensor 32 and the lens 36. Because the length or depth of the lens 36 of the camera 14 is directly proportional to the focal length of the lens 36 and inversely proportional to the field of view of the lens 36, cameras typically have an overall length or depth (such as 15 millimeters or more) to maintain minimum operating parameters such as focal length and field of view.

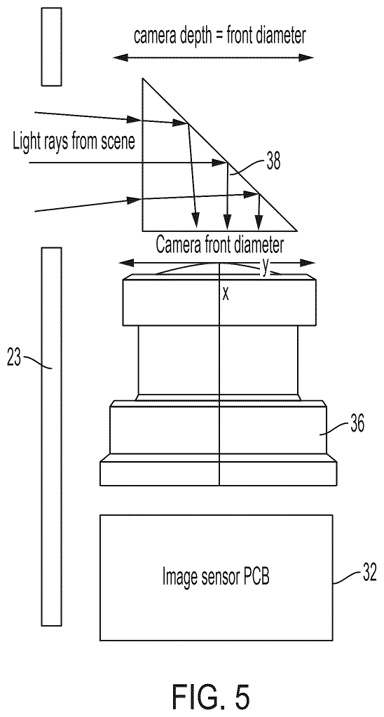

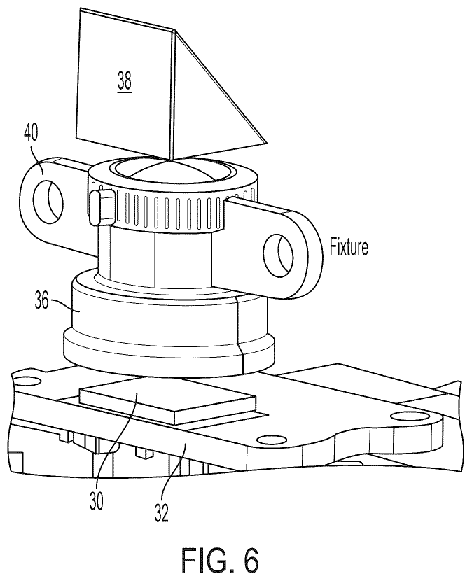

Referring to FIGS. 5 and 6, the camera 14 may be rotated within the vehicular component (such as by about 90 degrees) to reduce the packaging depth of the camera 14. That is, the imager PCB 34 and the image sensor 32 may be substantially perpendicular to a panel 23 of the vehicle component (e.g., the panel may comprise the mirror reflective element 22) with the lens 36 extending substantially parallel to and behind the outer surface. That is, a longitudinal axis of the lens 36 or a primary viewing axis of the camera 14 may be substantially parallel to the panel 23 of the vehicular component, or at an oblique angle such as about 10 degrees or less, 30 degrees or less, 45 degrees or less, 80 degrees or less, and the like.

The camera 14 views the interior portion of the interior cabin of the vehicle 10 based on light that passes through an aperture in the panel 23 of the vehicular component and that is reflected toward the lens 36 by a mirror or prism 38 disposed between the panel 23 of the vehicular component and the lens 36. Thus, the packaging depth of the camera 14 at the vehicular component may be reduced based on the diameter of the lens 36, such as to 15 millimeters or less, 10 millimeters or less, 8 millimeters or less, 5 millimeters or less and the like.

In the illustrated example, the prism 38 is disposed at or near or at least partially aligned with an aperture of the panel 23 and/or a portion of the panel 23 that is at least partially transparent to visible light and/or near infrared or infrared light. Light that passes through the panel 23 and is incident at the prism 38 is directed by the prism toward the lens 36 of the camera 14. For example, the prism 38 may be configured to internally reflect light that passes through the panel 23 and is incident at the prism 38, where the light is reflected at a substantially 90 degree angle so that the light passes through the lens 36 to be captured by the image sensor 30. Although shown as a wedge-shaped prism having a first facet or face facing the panel 23 and a second facet or face substantially perpendicular to the first face and facing the lens 36, it should be understood that any suitable reflection element may be utilized for directing light that passes through the panel 23 and toward the lens 36 with the lens 36 extending parallel to the panel 23. Thus, the image sensor 30 and/or imager PCB 32 may be disposed substantially perpendicular to the panel 23 with the lens 36 extending substantially parallel to the panel 23. This allows the packaging depth of the mirror assembly 18 (or other vehicular component) to be reduced to the diameter or width of the lens 36 and thus allows the overall depth of the mirror assembly 18 (or other vehicular component) to be reduced.

The lens 36 may include one or more wings or tabs 40 for attaching the lens 36 within the vehicular component. For example, each wing 40 may receive a threaded fastener or adhesive material for attaching the lens 36 to the mirror back plate or mirror casing.

Moreover, the camera 14 may be oriented in any suitable direction relative to the prism 38. For example, FIGS. 5 and 6 show the camera 14 disposed beneath the prism 38 such that the prism 38 reflects light incident thereat in a generally downward direction and at a substantially perpendicular angle relative to the panel 23. Optionally, the camera 14 may be disposed above the prism 38 (such that the prism 38 reflects light in a generally upward direction), along a side of the prism 38 (such that the prism 38 reflects light in a generally sideward direction), in a diagonal orientation and the like. Positioning of the camera 14 relative to the prism 38 may be based on packaging constraints within the interior rearview mirror assembly 18 or other vehicular component. Image data captured by the camera 14 may be rotated as needed during processing of the captured image data.

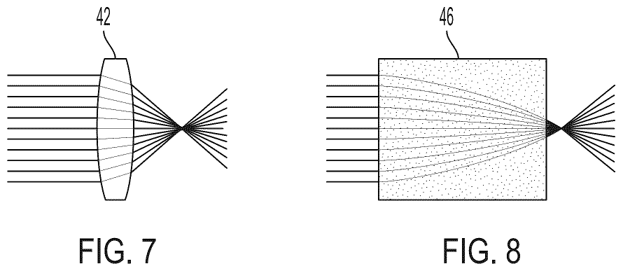

In some examples, and such as shown in FIG. 7, the camera objective may include one or more spherical lenses or optical elements 42 that are stacked relative to one another along a barrel structure. The spherical lenses 42 cooperate to focus light at the image sensor so that the camera 14 may view a region within the interior cabin of the vehicle. That is, as optical rays pass through the spherical lens 42, the spherical lens 42 produces a radially varying delay of the optical phase of the rays, causing the rays to converge. The radially varying phase delay is produced by the varied thickness of the spherical lens 42. However, these stacked spherical lenses must be precisely placed and/or spaced from one another along the barrel structure, which requires mechanical elements such as spacers, soma and complicated barrel structures. Moreover, the camera objective having spherical optical elements 42 tends to have an overall depth or length of 15 millimeters or greater and a front diameter of 8 millimeters or greater, which leads to an increased packaging space for the camera behind the vehicular component.

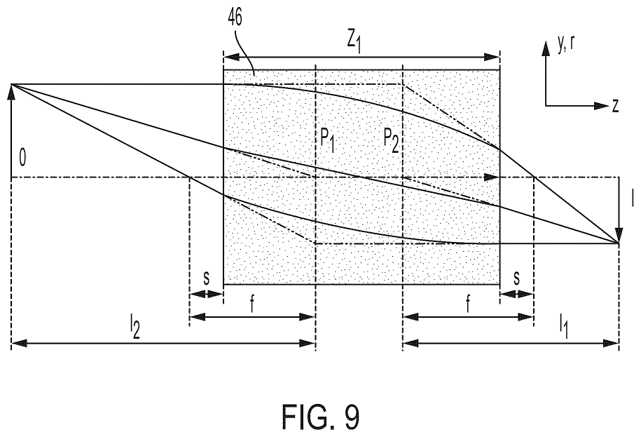

Referring to FIGS. 8-11, the camera 14 may include a lens or camera objective 44 that includes a gradient index (GRIN) lens 46 for focusing light incident at the camera 14 at the image sensor. The GRIN lens 46 has a constant thickness with a refractive index that varies in the radial direction relative to a longitudinal axis of the GRIN rod lens 46. That is, the GRIN lens 46 may be substantially rod-shaped or cylindrical-shaped with a substantially constant diameter along the longitudinal axis of the GRIN lens 46 and a radially varying refractive index. As shown in FIG. 9, the GRIN lens or GRIN rod lens 46 has a radially varying index of refraction that causes an optical ray to follow a sinusoidal propagation path through the lens. Further, the GRIN lens 46 combines refraction at the end surfaces along with continuous refraction within the lens. Thus, the GRIN lens 46 may achieve focus at the image sensor of the camera 14 via a singular rod-shaped lens element having a substantially uniform thickness and diameter with a refractive index that varies radially across the lens element. The GRIN lens may be formed via any suitable manufacturing process, whereby the refractive index varies in the material of the lens or at one or both sides or surfaces of the lens. For example, the GRIN lens 46 may be formed via material transformation techniques where the lens material may be processed to change the concentration of a particular element of the lens material, or the lens may be partially polymerized using ultraviolet light at varying intensities, or the like. In a particular example of a material transformation technique, a boron-rich glass material may be bombarded with neutrons to cause a change in the boron concentration and produce the refractive gradient. In another example, glass material may be immersed into a liquid melt with lithium ions, and sodium ions of the glass may be partially replaced with lithium ones via diffusion at different concentrations across the lens to produce the refractive gradient. In another example, phase separation of a specific glass may cause pores to form and these pores are filled with one or more salts or concentrations of salts to produce the refractive gradient. In yet another example, the substrate may be exposed to a laser with the laser dosage varied across the substrate (e.g., a variable scanning speed or laser power) to produce the refractive gradient. Further, the GRIN lens 46 may be formed via additive manufacturing techniques like three-dimensional (3D) printing or chemical vapor deposition (where glass with varying refractive indexes are deposited onto a substrate to produce the cumulative refractive change).

Focusing the light at the image sensor via the GRIN lens 46 may reduce the diameter of the camera objective lens 44 and reduce the packaging requirements of the camera 14. For example, the GRIN lens 46 may have a diameter that is 2.0 millimeters or less, 1.8 millimeters or less, 1.0 millimeter or less, 0.5 millimeters or less and the like.

Further, the GRIN lens 46 may provide for simpler construction of the objective lens 44 with fewer components. In some examples, the GRIN lens 46 replaces the objective lens 44, such that the camera includes the GRIN lens 46 and does not include other optic elements.

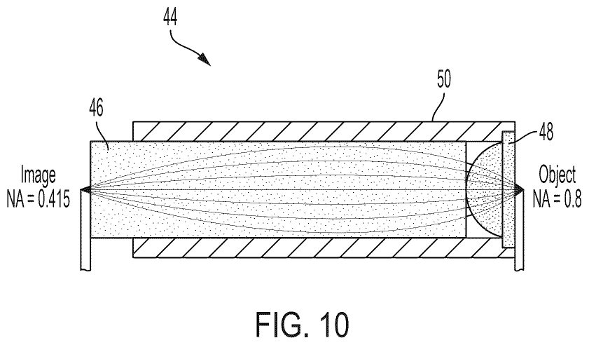

Optionally, the camera objective lens 44 may include a spherical lens, such as a plano-convex lens 48, at an end of the objective lens 44 including the GRIN lens 46 to achieve a high numerical aperture (NA), resulting in a wide field of view of the camera 14 (FIG. 10). In the illustrated example, the objective lens 44 includes the GRIN lens 46 and the plano-convex lens 48 axially aligned with one another at a barrel structure 50 of the objective lens 44. The convex end or surface of the plano-convex lens 48 faces one of the planar ends or surfaces of the GRIN lens 46 and the planar end or surface of the plano-convex lens 48 faces away from the GRIN lens 46. Optionally, the convex end of the plano-convex lens 48 engages the planar end of the GRIN lens 46. Thus, light incident at the objective lens 44 passes through the plano-convex lens 48 and the GRIN lens 46 to be incident at the image sensor of the camera 14. For example, the plano-convex lens 48 may be disposed at an end of the objective lens 44 nearest the image sensor so that light incident at the objective lens 44 passes first through the GRIN lens 46 and then through the plano-convex lens 48 to be disposed at the image sensor. Optionally, the plano-convex lens 48 may be disposed at an end of the objective lens 44 furthest from the image sensor so that light incident at the objective lens 44 passes first through the plano-convex lens 48 and then through the GRIN lens 46 to be disposed at the image sensor. The plano-convex lens 48 may have a NA of 0.8 and the GRIN lens 46 may have a NA of 0.415.

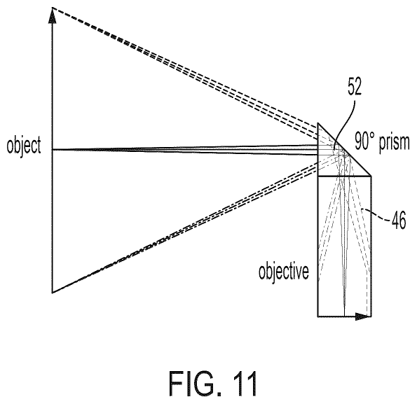

To further reduce the packaging requirements of the camera 14 within the vehicular component (e.g., the interior rearview mirror assembly), the camera 14 may be rotated within the vehicular component (such as by 90 degrees) and a mirror or prism 52 may be disposed in front of the GRIN lens 46 for reflecting light toward the imager of the camera (FIG. 11). That is, the imager PCB and the image sensor may be substantially perpendicular to the panel 23 (such as the mirror reflective element 22) with the GRIN lens 46 extending substantially parallel to and behind the panel 23. The camera 14 views the interior portion of the interior cabin of the vehicle 10 based on light that passes through the panel 23 and that is reflected toward the GRIN lens 46 by the prism 52 disposed between the panel 23 and the GRIN lens 46. Thus, the packaging depth of the camera 14 at the vehicular component may be reduced based on the diameter of the objective lens 44 having the GRIN lens 46, such as to two millimeters or less.

For example, the prism 52 may be disposed at or near or at least partially aligned with an aperture of the panel 23 and/or a portion of the panel 23 that is at least partially transparent to visible light and/or near infrared or infrared light. Light that passes through the panel 23 and is incident at the prism 52 is directed by the prism toward the GRIN lens 46 of the camera 14. For example, the prism 52 may be configured to internally reflect light that passes through the panel 23 and is incident at the prism 52, where the light is reflected at a substantially 90 degree angle so that the light passes through the GRIN lens 46 and is refracted by the GRIN lens 46 to be captured by the image sensor. Although shown as a wedge-shaped prism having a first facet or face facing the panel 23 and a second facet or face substantially perpendicular to the first face and facing the lens 46, it should be understood that any suitable reflection element may be utilized for directing light that passes through the panel 23 and toward the lens 46 with the lens 46 extending parallel to the panel 23. Optionally, the prism 52 may engage and/or be integrally formed with an end of the GRIN lens 46 opposite the image sensor. Thus, the image sensor and/or imager PCB may be disposed substantially perpendicular to the panel 23 with the GRIN lens 46 extending substantially parallel to the panel 23. This allows the packaging depth of the mirror assembly 18 (or other vehicular component) to be reduced to the diameter or width of the objective 44 including the GRIN lens and thus allows the overall depth of the mirror assembly 18 (or other vehicular component) to be reduced.

Although discussed herein as incorporating the camera behind an outer surface or outer panel of a vehicular component within the interior cabin of the vehicle, it should be understood that the camera may be positioned at the vehicle for capturing image data for any advanced driver assistance system (ADAS) of the vehicle. For example, the camera may be disposed behind an exterior body panel of the vehicle, such as at an A-pillar, a B-pillar, a C-pillar, a D-pillar, a door panel and the like. Optionally, the camera may be disposed at an exterior component of the vehicle, such as a door handle assembly. In these examples, the camera views regions exterior of the vehicle. Because the camera may have a reduced diameter and/or depth and/or because the camera may be positioned parallel to the outer surface of the exterior component of the vehicle with the prism directing or reflecting light incident at the outer surface (or a lens or aperture at the outer surface) toward the lens of the camera, the camera may view exterior of the vehicle through a reduced size aperture and/or with a reduced packaging depth of the camera behind the outer surface of the vehicle without sacrificing the focal length or field of view of the camera.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

The camera may be associated with a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication No. WO 2023/220222, and/or International Patent Application Ser. No. PCT/US25/27206, filed May 1, 2025 (Attorney Docket MAG04 FP5372WO), and/or International Patent Application No. PCT/US25/038021, filed Jul. 17, 2025 (Attorney Docket MAG04 FP5398WO), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The camera includes a lens and imaging sensor. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least two million photosensor elements or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at the interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular cabin monitoring system, the vehicular cabin monitoring system comprising:
a camera disposed at an interior portion of an interior cabin of a vehicle equipped with the vehicular cabin monitoring system;
wherein the camera is accommodated by a vehicular component within the interior cabin of the vehicle, and wherein the camera is accommodated by the vehicular component behind an outer panel of the vehicular component, and wherein the camera views within the interior cabin of the vehicle through a region of the outer panel of the vehicular component;
wherein the camera comprises (i) a printed circuit board (PCB), (ii) an image sensor disposed at the PCB and (iii) a gradient index (GRIN) lens;
wherein the image sensor comprises an imaging array having at least one million photosensors arranged in rows and columns;
wherein the camera is operable to capture image data;
wherein the GRIN lens comprises (i) a uniform thickness in an axial direction parallel to a longitudinal axis of the GRIN lens and (ii) a variable index of refraction in a radial direction perpendicular to the longitudinal axis of the GRIN lens;
wherein light incident at the region of the outer panel of the vehicular component (i) passes through the outer panel of the vehicular component, (ii) passes through the GRIN lens and (iii) is imaged at the image sensor of the camera;
an electronic control unit (ECU);
wherein image data captured by the camera is transferred to the ECU;
wherein the ECU comprises electronic circuitry and associated software, and wherein the electronic circuitry of the ECU comprises an image processor operable to process image data captured by the camera and transferred to the ECU; and
wherein image data captured by the camera and transferred to the ECU is processed at the ECU for at least one selected from the group consisting of (i) an occupant monitoring function and (ii) a driver monitoring function.

2. The vehicular cabin monitoring system of claim 1, wherein the camera is disposed at a mirror head of an interior rearview mirror assembly of the vehicle, and wherein the camera is movable together and in tandem with the mirror head when a driver of the vehicle adjusts a rearward view provided by a mirror reflective element of the interior rearview mirror assembly.

3. The vehicular cabin monitoring system of claim 2, wherein the outer panel comprises the mirror reflective element of the interior rearview mirror assembly.

4. The vehicular cabin monitoring system of claim 1, wherein an imager plane of the camera is parallel to a plane of the outer panel of the vehicular component, and wherein the longitudinal axis of the GRIN lens is perpendicular to the plane of the outer panel of the vehicular component.

5. The vehicular cabin monitoring system of claim 1, wherein a prism is accommodated by the vehicular component behind the outer panel of the vehicular component, and wherein the light incident at the region of the outer panel of the vehicular component passes through the outer panel of the vehicular component and is reflected by the prism to be incident at the GRIN lens.

6. The vehicular cabin monitoring system of claim 5, wherein an imager plane of the camera is perpendicular to a plane of the outer panel of the vehicular component, and wherein the longitudinal axis of the GRIN lens is parallel to the plane of the outer panel of the vehicular component.

7. The vehicular cabin monitoring system of claim 1, wherein the GRIN lens comprises part of an objective lens of the camera, and wherein the objective lens comprises a plano-convex lens, and wherein light incident at the region of the outer panel of the vehicular component passes through the GRIN lens and the plano-convex lens.

8. The vehicular cabin monitoring system of claim 7, wherein the plano-convex lens comprises (i) a convex surface that faces an end of the GRIN lens and (ii) a planar surface opposite the convex surface that faces away from the GRIN lens.

9. The vehicular cabin monitoring system of claim 1, wherein a diameter of the GRIN lens is less than or equal to 2 millimeters.

10. The vehicular cabin monitoring system of claim 1, wherein the vehicular component comprises a pillar of the vehicle.

11. The vehicular cabin monitoring system of claim 1, wherein the vehicular component comprises a gauge cluster of the vehicle.

12. The vehicular cabin monitoring system of claim 1, wherein the vehicular component comprises a display screen of the vehicle.

13. The vehicular cabin monitoring system of claim 1, wherein the region of the outer panel of the vehicular component comprises an aperture, and wherein light incident at the region of the outer panel of the vehicular component passes through the aperture of the outer panel of the vehicular component.

14. The vehicular cabin monitoring system of claim 1, wherein the outer panel is at least partially transmissive to light incident at the outer panel.

15. The vehicular cabin monitoring system of claim 1, wherein the camera includes only one GRIN lens.

16. A vehicular cabin monitoring system, the vehicular cabin monitoring system comprising:
a camera disposed at a mirror head of an interior rearview mirror assembly of a vehicle equipped with the vehicular cabin monitoring system;
wherein the camera is movable together and in tandem with the mirror head when a driver of the vehicle adjusts a rearward view provided by a mirror reflective element of the interior rearview mirror assembly;
wherein at least a region of the mirror reflective element of the interior rearview mirror assembly is at least partially transmissive to light incident at the mirror reflective element, and wherein the camera is accommodated by the mirror head behind the mirror reflective element of the interior rearview mirror assembly, and wherein the camera views within an interior cabin of the vehicle through the region of the mirror reflective element;
wherein the camera comprises (i) a printed circuit board (PCB), (ii) an image sensor disposed at the PCB and (iii) a gradient index (GRIN) lens;
wherein the image sensor comprises an imaging array having at least one million photosensors arranged in rows and columns;
wherein the camera is operable to capture image data;
wherein the GRIN lens comprises (i) a uniform thickness in an axial direction parallel to a longitudinal axis of the GRIN lens and (ii) a variable index of refraction in a radial direction perpendicular to the longitudinal axis of the GRIN lens;
wherein a diameter of the GRIN lens is less than or equal to 2 millimeters;
wherein light incident at the region of the mirror reflective element (i) passes through the mirror reflective element of the interior rearview mirror assembly, (ii) passes through the GRIN lens and (iii) is imaged at the image sensor of the camera;
an electronic control unit (ECU);
wherein image data captured by the camera is transferred to the ECU;
wherein the ECU comprises electronic circuitry and associated software, and wherein the electronic circuitry of the ECU comprises an image processor operable to process image data captured by the camera and transferred to the ECU; and
wherein image data captured by the camera and transferred to the ECU is processed at the ECU for at least one selected from the group consisting of (i) an occupant monitoring function and (ii) a driver monitoring function.

17. The vehicular cabin monitoring system of claim 16, wherein an imager plane of the camera is parallel to a plane of mirror reflective element of the interior rearview mirror assembly, and wherein the longitudinal axis of the GRIN lens is perpendicular to the plane of the mirror reflective element of the interior rearview mirror assembly.

18. The vehicular cabin monitoring system of claim 16, wherein a prism is accommodated by the mirror head behind the mirror reflective element of the interior rearview mirror assembly, and wherein the light incident at the region of the mirror reflective element is reflected by the prism to be incident at the GRIN lens.

19. A vehicular cabin monitoring system, the vehicular cabin monitoring system comprising:
a camera disposed at an interior portion of an interior cabin of a vehicle equipped with the vehicular cabin monitoring system;
wherein the camera is accommodated by a vehicular component within the interior cabin of the vehicle, and wherein the camera is accommodated by the vehicular component behind an outer panel of the vehicular component, and wherein the camera views within the interior cabin of the vehicle through a region of the outer panel of the vehicular component;
wherein the camera comprises (i) a printed circuit board (PCB), (ii) an image sensor disposed at the PCB and (iii) an objective lens;
wherein the objective lens includes (i) a gradient index (GRIN) lens and (ii) a plano-convex lens;
wherein the image sensor comprises an imaging array having at least one million photosensors arranged in rows and columns;
wherein the camera is operable to capture image data;
wherein the GRIN lens comprises (i) a uniform thickness in an axial direction parallel to a longitudinal axis of the GRIN lens and (ii) a variable index of refraction in a radial direction perpendicular to the longitudinal axis of the GRIN lens;
wherein the plano-convex lens comprises (i) a convex surface that faces an end of the GRIN lens and (ii) a planar surface opposite the convex surface that faces away from the GRIN lens;
wherein the region of the outer panel of the vehicular component comprises an aperture, and wherein light incident at the region of the outer panel of the vehicular component (i) passes through the aperture, (ii) passes through the GRIN lens, (iii) passes through the plano-convex lens and (iv) is imaged at the image sensor of the camera;
an electronic control unit (ECU);
wherein image data captured by the camera is transferred to the ECU;
wherein the ECU comprises electronic circuitry and associated software, and wherein the electronic circuitry of the ECU comprises an image processor operable to process image data captured by the camera and transferred to the ECU; and
wherein image data captured by the camera and transferred to the ECU is processed at the ECU for at least one selected from the group consisting of (i) an occupant monitoring function and (ii) a driver monitoring function.

20. The vehicular cabin monitoring system of claim 19, wherein the vehicular component comprises one selected from the group consisting of (i) a pillar of the vehicle, (ii) a gauge cluster of the vehicle and (iii) a display screen of the vehicle.
